(19) United States
(12) Patent Application Publication
(10) Pub. No.: US 2011/0079672 A1
(43) Pub. Date: Apr. 7, 2011

(54) AUTOMATIC EXTERNAL ADJUSTABLE SPOOL BRAKING SYSTEM

(76) Inventors: HYUNKYU KIM, Broken Arrow, OK (US); JUNGHYUN NAM, Incheon City (KR)

(21) Appl. No.: 12/574,931

(22) Filed: Oct. 7, 2009

(51) Int. Cl. A01K 89/033

(52) U.S. Cl. 242/289

(57) ABSTRACT

In a fishing reel, in addition to an externally adjustable brake system, an automatic spool brake system adjusts spool braking action dependent upon spool rotation speed to provide brake control for preventing backlash and to achieve better casting distance by reducing spool braking force at low spool rotation speeds. A brake assembly has a plurality of brake shoes and speed adjust shoes and is slidably mounted on a spool shaft. An adjustable brake ring selectively engages the brake shoes to provide a braking action to the spool. A spring is provided for biasing the brake assembly away from the brake. Centrifugal force causes the speed adjust shoes to migrate outwardly in contact with a conical surface. The shoes impart an axial force to the brake assembly for moving the assembly towards the brake ring. At lower speeds, the spring pushes the brake assembly away from the brake ring.

### FIELD OF THE INVENTION

The present invention relates to centrifugal brake systems on fishing reels and, more particularly, to an automatic brake system wherein braking action on the spool is dependent upon the rotation speed of the spool in addition to an infinitive external adjustment brake system.

### BACKGROUND OF THE INVENTION

Centrifugal brake systems are commonly used on casting reels to prevent backlash. Backlash may frequently occur when the line-carrying spool is rotating at high velocities. Commonly, a brake mechanism is mounted on the spool for rotation therewith. The brake mechanism has an associated brake pad that is urged radially outwardly against a brake surface on the reel housing by centrifugal forces produced by the rotation of the spool.

Centrifugal braking may have an adverse effect on casting distance. Therefore, with the development of easily adjustable brake systems, many fishermen set the brake control to “free” when pitching, which could result in backlash.

It is, therefore, desirable to provide a system wherein additional braking is provided at high spool spin velocities, but not at lower speed velocities, so as to maximize casting distance and to minimize backlash under conditions of long casting when brake control adjustments are set to “free”.

### SUMMARY OF THE INVENTION

A reel of the invention has a spool mounted on a spool shaft. A brake assembly is mounted on the spool shaft. The brake assembly has a plurality of brake shoes and a plurality of speed adjust shoes and is slidably mounted on the spool shaft. A brake ring selectively engages the brake shoes to provide a braking action to the spool. Preferably, braking force from the brake shoes against the brake ring is infinitely adjustable.

In a preferred embodiment, the spool has a conical surface for selectively engaging the speed adjust shoes. The brake assembly is slidably mounted on the spool shaft. The speed adjust shoes migrate outwardly to make contact with the conical surface when the spool and brake assembly are spun with sufficient velocity. When spun with sufficient velocity, the speed adjust shoes, acting against the conical surface, impart an axial force to the brake assembly for moving the brake assembly towards the brake ring. A speed adjust spring is provided for biasing the brake assembly away from the brake ring and towards the spool. The speed adjust shoes are sized so that the speed adjust shoes apply a centrifugal force against the conical surface at high rotational speeds of the spool and brake assembly, thereby causing the brake assembly to move towards the brake ring. At relatively lower rotational speeds of the spool, the speed adjust shoes cease to provide sufficient centrifugal force against the conical surface of the spool. Therefore, the speed adjust spring pushes the brake assembly away from the brake ring.

The automatic adjustable spool brake system of the invention automatically adjusts braking action on the spool dependent upon the spool rotation speed in addition to an infinitive externally adjustable brake system.

The result is better brake control to prevent backlash on casting and an ability to achieve better distance by reducing spool braking force when the spool rotation slows down, i.e., when the brake assembly returns to its original position by spring force.

Another benefit of the invention relates to the pitching function and casting combination. During pitching, many users set the brake to permit free spin of the spool assembly. A “free” setting may result in backlash when pitching without the benefit of traditional brake control adjust. Therefore, the apparatus of the invention addresses this difficulty by controlling backlash when pitching with the brake control adjust set at “free” by providing additional braking at high spool rotation velocities.

### BRIEF DESCRIPTION OF THE DRAWINGS

FIG. 1 is a perspective view of the reel of the invention;

FIG. 2 is an exploded view of palm side cover of the reel of FIG. 1 showing the infinitely adjustable ACS mechanism of the reel of FIG. 1;

FIG. 3 is a cross-sectional view of the reel of FIG. 1;

FIG. 4 is an exploded view of the brake shoe assembly of the reel of FIG. 1;

FIG. 5 is a cross-sectional view of the reel of FIG. 1 shown at a free position of the brake assembly and showing the brake shoe leveled;

FIG. 6 is a cross-sectional view of the reel of FIG. 1 showing the brake assembly moving forward due to spool momentum;

FIG. 7 is a cross-sectional view of the reel of FIG. 1 showing the brake ring assembly adjusted and moved forward due to momentum of the rotating spool;

FIG. 8 is a cross-sectional view of the reel of FIG. 1 showing the brake ring assembly adjusted and moved backwards due to slowing of the rotating spool.

### DETAILED DESCRIPTION OF THE PREFERRED EMBODIMENTS

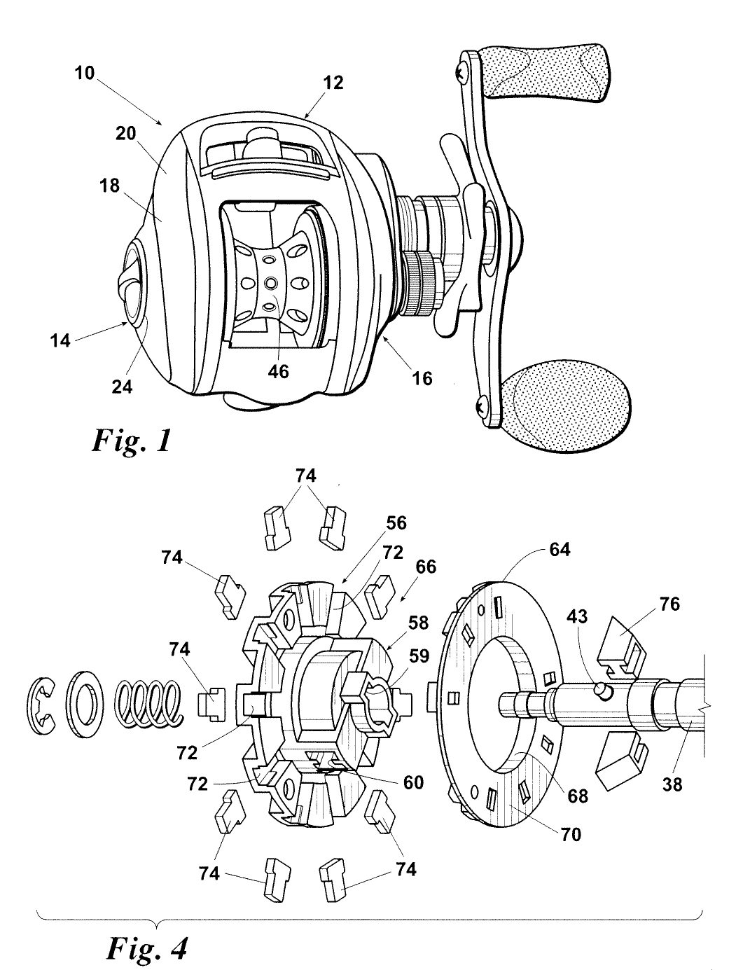

Shown in FIGS. 1-8 is a reel designated generally 10. Reel 10 includes frame 12 having palm side 14 and gear side 16. Palm side cover assembly 18 has outside surface 20 and inside surface 22. Inside surface 22 of palm side cover assembly 18 is affixed to palm side 14 of frame 12. Palm side cover assembly 18 defines dial orifice 24.

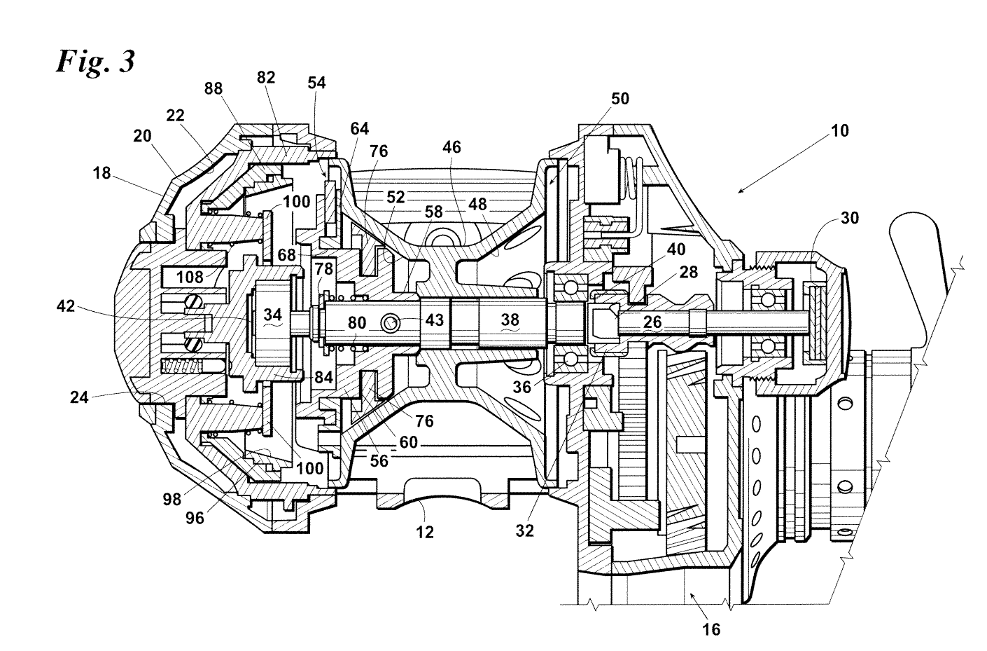

Crank shaft 26 (FIG. 3) is rotatably mounted within frame 12. Crank shaft 26 has a palm end 28 and a gear end 30. Pinion gear 32 is affixed to palm end 28 of crank shaft 26.

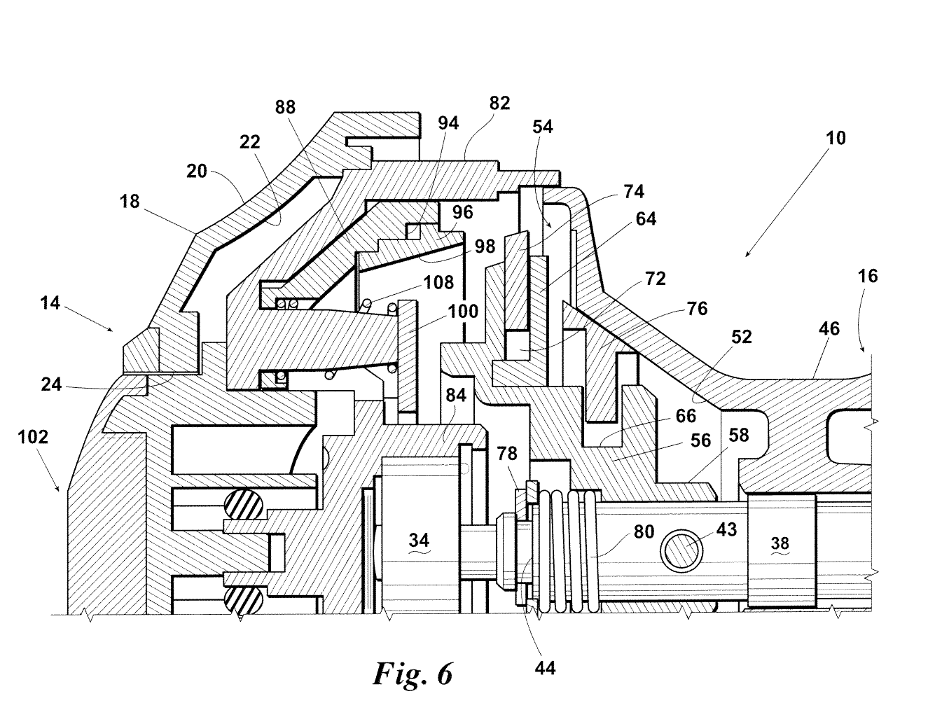

Spool shaft ball bearing 36 is mounted in gear side 16 of frame 12 for supporting gear end 40 of spool shaft 38. Spool shaft 38 has a gear end 40 and a palm end 42. Pin 43 protrudes from a side wall of spool shaft 38. Gear end 40 is supported by spool shaft bearing 36. Spool shaft 38 defines a clip receptacle 44 (FIGS. 6-8) proximate to palm end 42. Pin 43 protrudes from spool shaft 38.

Palm side spool shaft ball bearing 45 supports palm end 42 of spool shaft 38. Palm side ball bearing 34 is received within central member 84 of brake spool cover 82, discussed below.

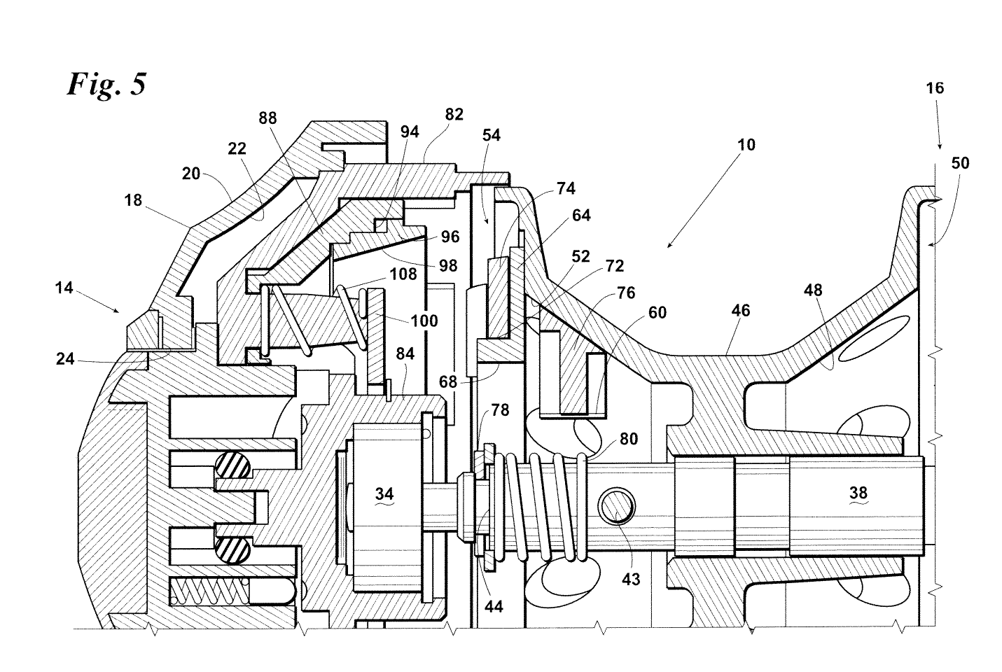

Spool assembly 46 is mounted on spool shaft 38. Spool assembly 46 defines conical surface 48 (FIGS. 3, 5) on gear side 50 and defines a conical surface 52 on palm side 54.

Referring now primarily to FIG. 4, but also to FIGS. 6-8, shown is a brake assembly. “Brake assembly” refers to the combination of brake shoe retainer 56, brake shoe holder 64, brake shoes 74, and speed adjust shoes 76. Brake shoe retainer 56 defines central protuberance 58. A plurality of speed adjust shoe retainers 60 are defined by central protuberance 58 of brake shoe retainer 56. Central protuberance 58 defines an orifice for receiving spool shaft 38. The orifice additionally defines pin slot 59 for receiving pin 43.

Brake shoe holder 64 is affixed to gear side 66 of brake shoe retainer 56 and surrounds spool shaft 38. Brake shoe holder 64 has a central orifice 68 for receiving central protuberance 58 of brake shoe retainer 56. Brake shoe holder 64 additionally defines a smooth gear side surface 70 (best seen in FIG. 4). Brake shoe holder 64 and brake shoe retainer 56 define a plurality of brake shoe receptacles 72 therebetween.

Brake shoes 74 are slidably retained within each of a plurality of brake shoe receptacles 72. Brake shoes 74 are free to slide in a radial direction. Movement of brake shoes 74 is restricted in an axial or thrust direction by brake shoe holder 64 and brake shoe retainer 56. A speed adjust shoe 76 is retained within each of the plurality of speed adjust shoe retainers 60 defined by the central protuberance 58 of brake shoe retainer 56. Speed adjust shoes 76 have a surface in sliding contact with conical exterior surface 52 of palm side 54 of spool assembly 46. Speed adjust shoe 76 additionally has a surface in sliding contact with smooth gear side surface 70 of brake shoe holder 64.

Speed adjust retainer clip 78 (FIGS. 3, 5, 6) is located in clip receptacle 44 on spool shaft 38. Speed adjust spring 80 is provided for biasing brake shoe retainer 56 towards gear side 16 of frame 12 so that speed adjust shoe 76 is pressed into a fully retracted position within brake shoe retainer 56 by palm side conical exterior surface 52 of spool assembly 46.

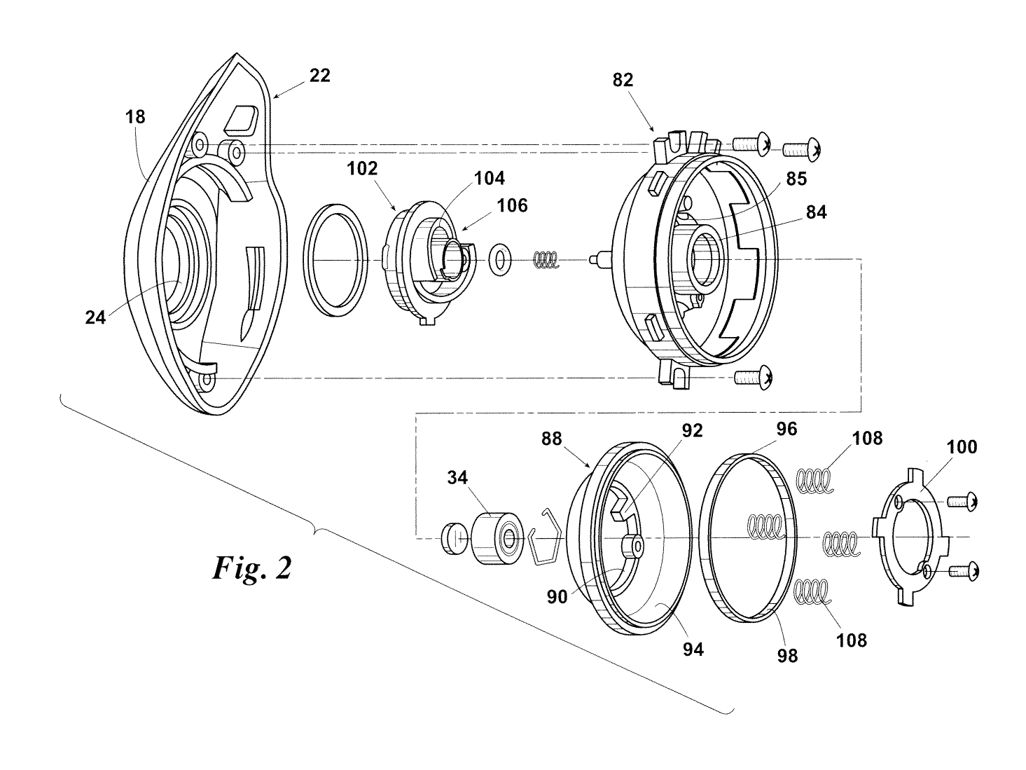

Brake spool cover 82 (FIG. 2) is affixed to inside surface 22 of palm side cover assembly 18. Brake spool cover 82 has a central member 84. Central member 84 is raised above a lower surface of brake spool cover 82 by a plurality of legs 85.

Still referring to FIG. 2, brake ring support 88 has a central orifice 90 that receives central member 84 of brake spool cover 82. Brake ring support 88 defines a cam follower 92 and a brake receiving area 94. Cam follower 92 passes between the legs of brake spool cover 82 to make contact with cam surface 104 for moving brake spool cover 82 in an axial direction, depending upon the rotation of brake control dial 102, discussed below.

Continuing with reference to FIG. 2, brake ring 96 is located within brake receiving area 94 of brake ring support 88. Brake ring 96 has a sloped brake shoe engaging surface 98 (see also FIGS. 3, 5-8). Brake ring slider spring retainer 100 is affixed to a gear side of brake spool cover 82.

Infinitely adjustable brake control dial 102 defines cam surface 104 on gear side 106. Cam surface 104 is received within a space defined in part by a palm side surface of central member 84 and in part by legs 85 to make contact with cam follower 92 of brake ring support 88, which passes therethrough. A plurality of brake frame assembly springs 108 are in contact with brake ring slider spring retainer 100 and bias cam follower 92 of brake ring support 88 into contact with cam surface 104 of brake control dial 102.

By turning infinitely adjustable brake control dial 102, a location of brake ring support 88 can be set to any position depending on the orientation of cam surfaces 104. Brake ring support 88 is biased against cam surfaces 104 by springs 108. The result is that the position of brake ring 96 may be infinitely adjustable with regard to brake shoe retainer 56.

The brake shoe assembly, including brake shoe retainer 56 and brake shoe holder 64, is free to slide in an axial or thrust direction along spool shaft 38. The axial movement results in pin 43 moving within pin slot 59. The brake shoe retainer 56 is biased towards gear side 16 by speed adjust spring 80. Therefore, brake shoe retainer 56 can slide forward when a thrust force from speed adjust shoes 76 is greater than the spring force from speed adjust spring 80. When spool rotation speed slows and the axial thrust force generated by speed adjust shoes 76 diminishes, brake shoe retainer 56 then returns to its original position due to the spring force from speed adjust spring 80. Auto adjusting speed adjust shoes 76 slide within adjust shoe retainers 60, so speed adjust shoes 76 may extend in a radial direction for applying force to conical surface 52 of spool 46.

In greater detail, when spool assembly 46 over spins when casting, speed adjust shoes 76 move outwardly and push against conical surface 52 of spool assembly 46. The outwardly directed force of auto speed adjust shoes 76 causes speed adjust shoes 76 to slide along conical surface 52 outwardly and in the direction of brake ring support 88. Brake shoe retainer 56 is, therefore, moved when the axial vector force is greater than the spring force from speed adjust spring 80. Braking force is then generated when brake shoes 74 move to engage brake ring support 88.

Referring now to the section views of FIGS. 5-8, it can be seen that FIG. 5 shows reel 10 at a resting and full free position. In this position, speed adjust shoes 76 are in a fully retracted position within speed shoe retainers 60 by conical surface 52 of spool assembly 46. Brake shoe retainer 56 is pressed towards gear side 16, i.e., fully within conical surface 52 by speed adjust support spring 80 (see FIG. 3). Brake shoes 74 are retracted within brake shoe receptacles 72 and do not make contact with sloped brake shoe engaging surface 98 of brake ring 96.

FIG. 6 shows reel 10 at a casted condition and full free position. In the position shown in FIG. 6, speed adjust shoes 76 are extended from speed shoe retainers 60. Centrifugal force moves speed adjust shoes 76 outwardly. An outside surface of speed adjust shoes 76 are in contact with conical surface 52 of spool assembly 46. Speed adjust shoes 76 are, therefore, providing an axial force component for moving brake shoe retainer 56 towards palm side 14. Brake shoes 74 are likewise extended from brake shoe receptacles 72, but do not make contact with sloped brake shoe engaging surface 98 of brake ring 96.

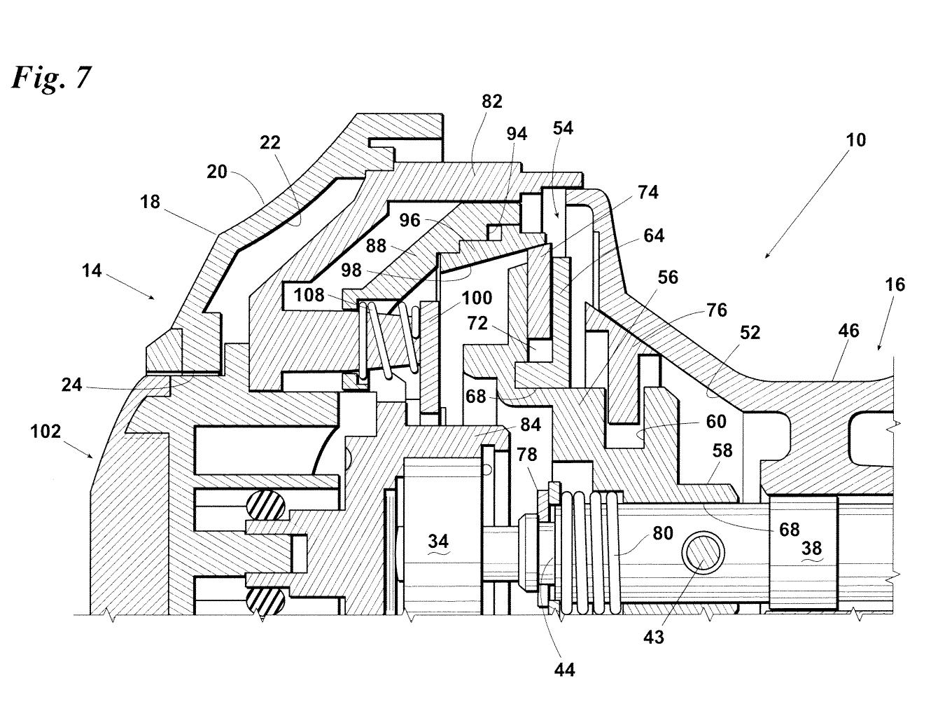

FIG. 7 shows the reel at a casted position and the infinite ACS dial 102 of reel 10 adjusted half way. In the position shown in FIG. 7, speed adjust shoes 76 are extended from speed shoe retainers 60. An outside surface of speed adjust shoes 76 is in contact with conical surface 52 of spool assembly 46. Speed adjust shoes 76 are, therefore, providing an axial force component for moving brake shoe retainer 56 toward palm side 14. Brake shoes 74 are likewise extended from brake shoe receptacles 72 and make frictional braking contact with sloped brake shoe engaging surface 98 of brake ring 96 to provide a braking force.

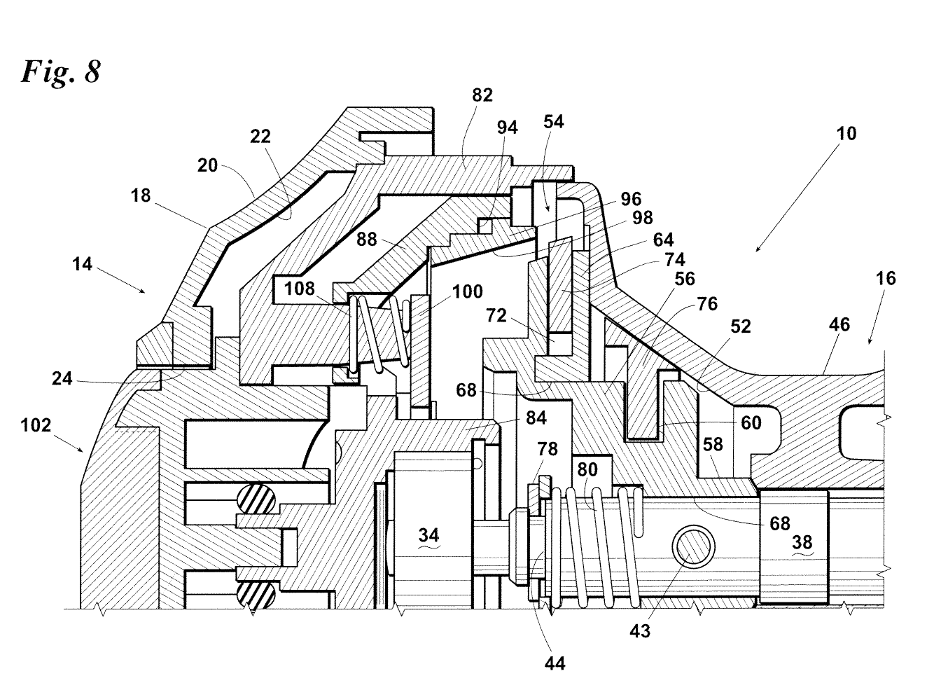

FIG. 8 shows the infinite ACS dial 102 of reel 10 adjusted halfway and shows reel 10 when the brake assembly is returning to its original position. The brake shoe retainer 56 is shown moving away from braking surface 98 when the speed of spool assembly 46 is reducing. In the position shown in FIG. 8, speed adjust shoes 76 are retracting into speed shoe retainers 60 and are not generating a sufficient axial force to overcome spring force from spring 80. Brake shoe retainer 56 is, therefore, moving towards gear side 16. Brake shoes 74 are moved out of contact with sloped brake shoe engaging surface 98 of brake ring 96. Therefore, spool assembly 46 is in a relatively low-friction condition as the speed of spool assembly 46 is reducing.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A reel comprising:
a spool mounted on a spool shaft;
a brake assembly mounted on said spool shaft, said brake assembly having a plurality of brake shoes and a plurality of speed adjust shoes;
a brake ring for selectively engaging said brake shoes:
a conical surface for selectively engaging said speed adjust shoes;
wherein said brake assembly is slidably mounted on said spool shaft;
wherein said speed adjust shoes migrate outwardly in contact with said conical surface when said brake assembly is spun with sufficient velocity and said speed adjust shoes impart an axial force to said brake assembly for moving said brake assembly towards said brake ring.

2. The reel according to claim 1 wherein:
said conical surface is part of said spool.

3. The reel according to claim 1 further comprising:
a speed adjust spring for biasing said brake assembly away from said brake ring and towards said spool;
wherein said speed adjust shoes are sized so that said speed adjust shoes apply a centrifugal force against said conical surface at high rotational speeds of said spool, thereby causing said brake assembly to move towards said brake ring, and wherein said speed adjust shoes cease to provide said centrifugal force against said conical surface at relatively lower rotational speeds of said spool thereby causing said speed adjust spring to push said brake assembly away from said brake ring.

4. The reel according to claim 1 wherein:
braking force from said brake shoes against said brake ring is infinitely adjustable.

5. A reel comprising:
a spool;
a brake ring in said spool;
a plurality of brake shoes for selectively engaging said brake ring for resisting rotation of said spool;
a plurality of speed adjust shoes for moving said brake shoes towards said brake ring of said spool at high spool velocity, and away from said brake ring at relatively lower spool velocity.

6. The reel according to claim 5 wherein:
said speed adjust shoes apply a force component that is parallel to a longitudinal axis of said spool for causing said spool to move axially.

7. The reel according to claim 6 further comprising:
a speed adjust spring for resisting said axial movement of said spool;
wherein said force component is sufficient to overcome a spring force of said speed adjust spring at high spool rotation velocities, but not at relatively lower spool velocities.

8. The reel according to claim 5 wherein:
said brake shoes may be subjected to an infinite adjustability wherein a rotation resistance resulting from contact of said brake shoes with said brake ring may be adjusted from zero to a maximum value.

9. A reel comprising:
a spool;
a plurality of brake shoes slidably mounted in a brake shoe retainer for selectively resisting rotation of said spool;
wherein said brake shoe retainer is axially movable with regard to said spool for increasing or decreasing a braking force depending on a rotational velocity of said spool.

10. The reel according to claim 9 further comprising:
a plurality of speed adjust shoes for imparting an axial force on said brake shoe retainer at relatively high rotation velocity of said spool.
